(19) United States
(12) Patent Application Publication
(10) Pub. No.: US 2007/0288319 A1
(43) Pub. Date: Dec. 13, 2007

(54) SYSTEM AND METHOD FOR TRANSFERRING BIOMETRICALLY ACCESSED REDEMPTION RIGHTS

(76) Inventors: Timothy L. Robinson, Reston, VA (US); Bradford R. Schildt, Boulder, CO (US); Tennille V. Goff, Springfield, VA (US); Daniel J. Corwin, Canonsburg, PA (US); Timothy N. Watson, Washington, DC (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/830,994

(22) Filed: Jul. 31, 2007

Related U.S. Application Data
(63) Continuation-in-part of application No. 11/187,836, filed on Jul. 25, 2005.
(60) Provisional application No. 60/820,825, filed on Jul. 31, 2006.

(51) Int. Cl. G06Q 30/00

(52) U.S. Cl. 705/14

(57) ABSTRACT

A system and method of offering a redemption account that allows users to purchase or reserve and subsequently redeem, share, transfer, or resell redemption rights for items from one or more merchants that are affiliated with the system is disclosed. The present invention imparts a process by which users enrolled in a biometric redemption rights system can access redemption rights for advance purchased or reserved items by submitting their biometric data. Information stored in the user record can then be utilized to enable the sharing, transfer, resale or fulfillment of the redemption rights.

### CROSS-REFERENCE TO RELATED APPLICATIONS

This application claims priority benefit under 35 U.S.C. § 119(e) from provisional application No. 60/820,825, filed Jul. 31, 2006, and is a continuation-in-part of application Ser. No. 11/187,836, filed Jul. 25, 2005. Each above-identified application is incorporated by reference herein, in its entirety, for all purposes.

### TECHNICAL FIELD

This application relates generally to the reservation, advance purchase and redemption of products or services. More particularly, the present invention relates to a system and method for transferring redemption rights for advance purchased or reserved goods and services among biometrically enabled user records.

### BACKGROUND

Merchants who sell redemption rights to access products or services, such as concerts, other events, or theme parks, may suffer losses due to the unauthorized resale or transfer of those redemption rights to third parties. For example, a season pass holder to a theme park might allow friends and relatives to utilize the pass, or a traveler who pre-purchased a week-long pass to a theme park might use only a portion of the week, and resell the pass to a second traveler who could redeem the remaining time. The theme park operator is thus deprived of potential revenue from the second traveler. “Gray market” resellers might also take advantage of these advance purchase sales, which are often discounted, by reselling the passes, tokens, tickets, and so forth that represent the redemption rights at a higher price than initially paid, but lower than the price at which the merchant offers them, thus depriving the merchant of a potential full-price sale. To counteract such problems with unauthorized transfer or gray market resale of redemption rights, many event and theme park operators make redemption rights contingent upon the presentation of a user biometric or other user identifiers that may not be transferred with the ease of a physical ticket or other token. But users who might legitimately wish to transfer a redemption right to a third party, for example, if they are unable to attend an event or take a flight, are often unable to do so in these systems. For example, an initial user who has reserved a hotel room but can no longer make a planned trip might wish to transfer the reservation to a friend rather than cancel the reservation. Even if a merchant offers a means for redemption rights transfer, for example, by allowing a customer to email an e-ticket to a third party, such redemption rights management methods are typically designed to discourage large scale, gray market resellers and, therefore, may unintentionally inconvenience average consumers who wish to resell or transfer their redemption right.

In addition to problems for merchants, individuals lack protection from potential fraud. For example, some methods of redemption can be easily duplicated or counterfeited, such as a printed e-ticket containing a barcode that is scanned to allow access to an event. An unscrupulous holder of a bar-coded paper ticket, printed from a website for instance, might make multiple copies and sell them to unsuspecting third parties. Individuals thus lack a means of determining if they are the only person to whom a redemption right have been resold

### SUMMARY

The present invention provides a rights transfer method utilizing a biometric redemption rights system (BRRS) for securely sharing or transferring redemption rights between an initial purchasing user and additional users, while allowing implementation of rules governing the transfers as necessary.

In an embodiment, a method for transferring ownership of a redemption right in a biometric redemption rights system from an initial user to a second user may include receiving purchase information related to one or more items to be redeemed at a later date, storing, in a user record associated with registered biometric data of the initial user, information pertaining to a redemption right relating to the one or more items, which authorizes the initial user to redeem the one or more items upon provision of biometric data matching the registered biometric data, receiving, from the initial user, a request to transfer ownership of the redemption right to a second user, determining whether the transfer request meets at least one approval guideline for ownership transfer, and transferring ownership of the redemption right to the second user. Transferring ownership may include storing the redemption right in a user record associated with registered biometric data of the second user and may authorize the second user to redeem the one or more items upon presentation of the biometric data of the second user.

In an embodiment, a method for sharing redemption rights between users enrolled in a biometric redemption rights system may include receiving, at an authorization station, purchase information related to one or more items redeemable at a select set of operators, storing redemption rights information related to the one or more items in a user record associated with registered biometric data of the initial user, receiving a request from the initial user to enable a second user to utilize the redemption rights information, and storing the redemption rights information relating to the one or more items in a user record of the second user. The user record may include registered biometric data of the second user. Storing the redemption rights information in the user record of the second user may enable the second user to redeem the one or more items upon provision of biometric data matching the registered biometric data.

In an embodiment, a method in a biometric system for transferring a reservation request may include receiving a user reservation request including a reservation of a right to purchase a product offered by an operator in communication with the system, storing reservation information related to the reservation request in association with user biometric data, which indicates user ownership of the reservation request, receiving a user transfer request indicating a transfer of ownership of the reservation request to a third party, wherein the user transfer request comprises user biometric data, approving the transfer request if the transfer request meets at least one approval guideline, storing reservation information related to the reservation request in association with third party biometric data, which indicates third party ownership of the reservation request, and communicating the reservation information to the operator.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof that are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a general architecture overview of an exemplary biometric redemption rights system (BRRS) that supports the present invention.

FIG. 2 illustrates a flowchart of a process of redeeming or accessing advance purchased or reserved products, events and accommodations from selected vendors via a user record maintained by a BRRS.

FIG. 3 illustrates a flowchart of a process for reservation, advance purchase and transfer of redemption rights via a BRRS.

### DETAILED DESCRIPTION

Various embodiments of the invention are discussed in detail below. While specific implementations are discussed, it should be understood that this is done for illustration purposes only. A person with ordinary skill in the relevant art will recognize that other components and configurations may be used without parting from the spirit and scope of the invention.

Methods of accessing, redeeming and transferring reserved and/or advance purchase accommodations, events, food and beverage, transportation and the like typically require that purchasers wear or carry tokens, such as wristbands or paper tickets, or present convention confirmation of their identity to access the goods and services. Such tokens and IDs may be easily lost, misplaced or stolen, and tickets or access tokens may also be sold to other individuals without merchant approval, sometimes at a higher price than that paid by the initial purchaser. This “gray market” might be particularly troublesome to a merchant that sold the original package or event access at a discounted rate; an unscrupulous user might undercut the merchant's price at the point of access and still turn a profit on the transaction. For example, a customer could purchase discounted access to a theme park at a remote location and attempt to resell the discounted access at a point of entry to visitors who would otherwise likely pay the full entry price.

Additionally, travel and vacation destinations often involve locales, such as beaches or ski slopes where carrying cash, identification and/or financial tokens to purchase refreshments or gain access to events is inconvenient. Reducing the necessity to carry such tokens would lessen a traveler's risk of loss through theft or fraud, and merchant risk of loss due to counterfeited tickets and tokens would also be reduced.

These difficulties may be overcome by offering biometrically-accessed user records containing information about redemption rights to reserved or advance purchased items thus allowing users to buy items in advance from one or more merchants that have chosen to affiliate with and offer their services through a biometric redemption rights system. An item includes one or more of a product and a service. In some instances, the redemption rights could indicate a specified value redeemable at select locations, while in other instances, the redemption rights could indicate a number of particular items, events, or services that the user can redeem (e.g., present his redemption rights in exchange for a portion or all of the designated product or service) at his destination.

The storing of information regarding a redemption right in a biometrically accessed user record offers a significant advantage to purchasers of pre-arranged packages or event access by allowing them to access events, products or services they have paid for without tickets, wrist bracelets, IDs, or other types of tokens that may be easily lost or stolen. In the biometric redemption rights system, the user submits biometric data before, at, or subsequent to the time of purchase that can then be used to access the redemption rights to products or services to the extent that the user is eligible. Additional advantages include the inherent security of a biometric system; the redeeming user need not worry about theft or fraud that might result from lost, stolen or duplicated tickets and tokens.

Another advantage of the BRRS that supports the present invention is that it allows sellers of advance purchase packages or event access to confirm that users who redeem their purchases are eligible to do so. For example, a spring break traveler who pre-purchased access to age-restricted beverages or event locations can verify his age and identity by submitting his biometric data. This can help protect merchants from liability issues associated with under-aged drinkers, since biometric redemption rights cannot be sold or traded with the ease of wristbands or other tokens, while affording the purchaser the convenience of leaving behind his wallet and identification tokens. It also allows for a merchant who allows redemption rights transfers to be assured that the person redeeming the products or services has also been verified as meeting age or other eligibility requirements.

As another advantage, the BRRS offers merchants a means for generating new business and increasing customer traffic by pre-selling access to their products or services, for example, as part of a package offered to vacation travelers. A traveler will be more likely to choose a product or service provider that is part of an attractive, pre-selected, and possibly discounted, package than other providers. Such a package becomes particularly appealing to the vacation traveler when it is redeemable with the simplicity and convenience of biometric authorization, rather than tokens, tickets, vouchers, conventional IDs and the like. Combining the convenience and security of this system with flexible and secure methods of reselling, sharing or transferring a redemption right creates added incentive for customers to make use of the system.

The present invention leverages this biometric redemption rights system by providing a means for a user other than the initial user to be authorized to redeem the advance purchase. Such authorization could occur at the initial purchase, or the initial user could add authorization to one or more additional users, provided that the additional users are able to present biometric data or other identifying data to the system. For example, a user who purchases a redemption right to a theme park admission could designate one or more additional users as authorized to redeem the redemption right and provide necessary identity-verification information about the authorized individuals to enable their redemption. In one scenario an initial user whose advance purchase includes access to Disney World for her family might additionally authorize her husband and one or more of her children as additional users for redemption of the access, even should the initial user herself might not be present at redemption authorization. The authorized additional users could already be enrolled and have user records in the system, could submit necessary information for enrollment at the time of purchase, or could submit the necessary information, such as their biometric data and other enrollment information, at a system kiosk or other authorization station subsequent to the purchase but prior to rights. In another embodiment, the additional users could redeem pre-purchased items without registering biometric data with the BRRS, so long as they were accompanied by the enrolled initial user. For example, the mother who pre-purchases access for her family to Disney World as part of a vacation package might redeem access for five persons, including herself her husband, and three children, by presenting her biometric data at an entry authorization station. Information contained in her user record could indicate that her redemption was valid for the number of persons authorized by the advance purchase. The initial user could additionally place limitations on the pre-purchased products or services that additional users could redeem. For example, the initial user might authorize her children for access to Disney World, but not for pre-purchased food or beverage services, the redemption of which could still require the initial user's presence at the redemption point. The redemption right and limitation information could be stored in the user records of the children, or their user records might simply contain an identifier, such as a system identification code (SID) (e.g. a unique alphanumeric code) of the mother that would direct the system to search for redemption rights information and limitations in the mother's user record.

The initial user could also transfer the redemption right for the advance purchase to a second user. In this embodiment, the initial user relinquishes the redemption right to the second user, rather than adding additional authorized users. For example, the user might be unable to attend an advance purchased event, such as a concert, and authorize a second user to redeem his purchase. The initial user could provide necessary information about the second user to enable transfer of the authorization. For example, if the second user is enrolled in the biometric redemption rights system, the purchasing user could provide the second user's name or a system identification code via a system website, kiosk, email, and the like. If the second user is not enrolled in the system, the purchasing user could communicate information to the second user to enable the transfer. For example, the redemption rights transfer system could provide the purchasing user with a pass code related to the advance purchase, which could be communicated via email to the second user either by the system or the initial user. The second user could then enroll in the system at an authorization station, such as a kiosk, service desk, web site or mobile communication device, by submitting required identification information and their biometric data. The enrolled second user could then submit the pass code received from the system or initial user in order to enable the transfer of redemption authorization for the advance purchase, provided that the transfer meets system and/or operator approval guidelines.

In general, a biometric authorization refers to an authorization in which either a user, typically a customer purchasing or seeking to access a redemption right in the system, an operator, or a system representative, such as an employee of the BRRS service provider, provides biometric data to be matched against a biometric record in a database. For the purposes of this invention, an operator could be a merchant, merchant entity or merchant employee utilizing the BRRS to offer a biometrically accessed redemption right to items, and the term operator may refer to the merchant entity, an individual merchant, or to a merchant employee, such as a store clerk or travel agent. Though operator generally refers to merchants for the purposes of this invention, it will be understood that an operator could be any entity or individual (other than the BRRS service provider and its employees) engaged in the provision or administration of redemption rights to biometrically accessed items. A user may undergo biometric authorization to transfer redemption right, complete a financial transaction or to gain access to an age-restricted product. As would be appreciated, the location of the database as well as the specific mechanism by which the biometric data is matched to a particular biometric record would he implementation dependent and would not be limiting on the scope of the present invention. Thus, in a biometric authorization, the biometric data taken during the authorization can be matched against registered biometric data at a location where the registered biometric data is stored or where the authorization biometric data is gathered. In addition, biometric data received during an authorization can be tested for liveness to prevent system fraud.

Additionally, the principles of the present invention are not limited to using one form of biometric. For example, the biometric data referred to throughout this description can represent a biometric image (or sample) and/or a mathematical representation of the biometric image, often referred to as a biometric “template.” In one example, a biometric template can represent any data format that includes feature, positional, or other representing information of characteristics of biometric data. Alternatively, a template can be a mathematical representation of more than one biometric. For example, a user template may be generated from biometric data acquired from two individual fingers, such as a thumb and index finger, or from a finger and an iris scan. The biometric data can include fingerprint data, iris data, facial data, voice data, retinal data, hand architecture data, DNA data, or any other physical measurement pertaining to a user's person.

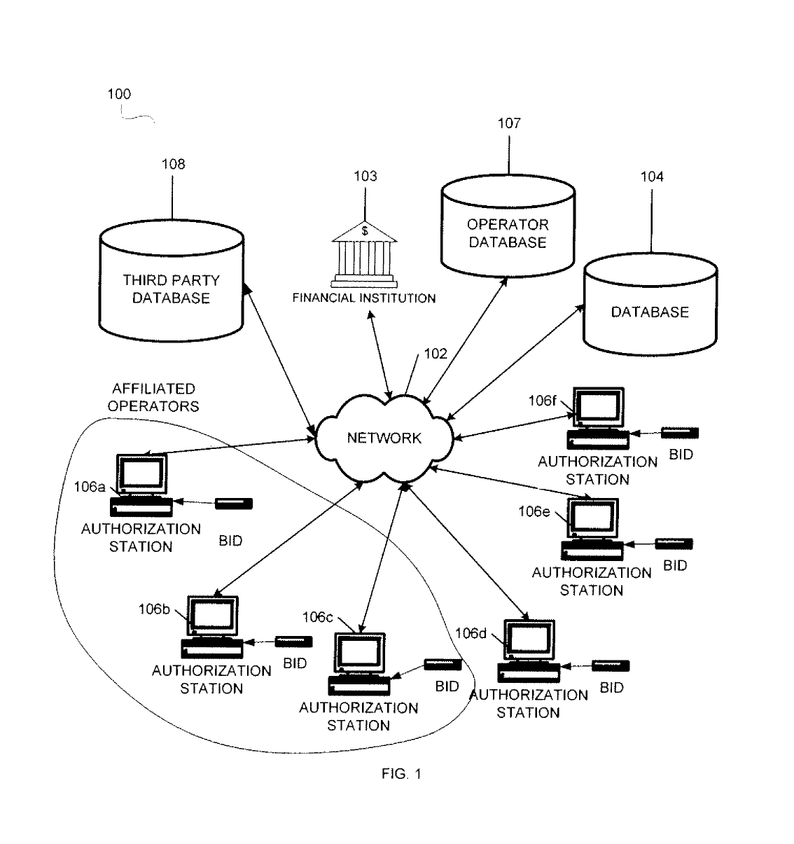

FIG. 1 illustrates a general architecture overview of a BRRS 100 within which the present invention enabling redemption rights access and transfer may be implemented. As will be described in greater detail below, the BRRS 100 enables a convenient redemption and transfer process for advance purchased items for users. Transaction information, which could include information such as the type, amount, or value of the advance purchased items, as well as any limitations and/or conditions of their redemption, is stored in database 104 in association with a user record. The invention's database 104 is connected to a network 102, such as, but not limited, to the Internet. As illustrated in FIG. 1, network 102 is connected to an operator database 107 registered with the system (e.g. a database belonging to a participating merchant) and to financial institution 103, which could represent financial institutions where the user is an account holder as well as the financial institutions maintaining the accounts of one or more operators offering redemption rights for sale. As would be apparent to those skilled in the art of the present invention, other entities could perform the functions of operator database 107 and financial institution 103 without departing from the scope of the present invention. For example, some or all of the functions of these two entities could be performed within database 104. Thus, database 104 could represent one or more databases utilized within the system. Database 104 can be a central database to which all user records are stored and from which user records are accessed for biometric authorization and/or pre-purchased transaction redemption. In another embodiment, database 104 also includes one or more operator databases to which a select set of operator records are stored and from which a select set of operator records are accessed if needed, for example for biometric authorization or tracking of operator employees, or for use of stored biometric data as an operator identifier. In general, embodiments utilizing a combination of databases enable increased control of information flow throughout BRRS 100. As described in detail below, various examples of information flow configurations within the biometric redemption rights system can include both a shared set of affiliated operators and “closed” system models. In the present invention, user information contained in the stored user records could be shared among a select set of affiliated operators offering items as part of an advance purchased package. In an alternative embodiment, database 104 can further comprise one or more sub-databases that are contained within a particular database. In such embodiments, user data, operator data, and other system data may be distributed across multiple databases within database 104

A user record holds a variety of information allowing BRRS 100 to provide highly flexible functionality for advance purchase transactions, transfers and redemptions. When enrolling in BRRS 100, a user can present any number of identity verifying documents or testaments to his identity depending on the implementation of the system. By way of illustration and not of limitation, examples of such documents or testaments include a financial token, a digital image, a video clip family information, a DNA sample, government identification or work identification. A user record holds user identifying data that can be employed by BRRS 100 to identify a user redeeming an advance purchase, such as a user's biometric data, preexisting token data and/or user-knowledge-based, “out of wallet” information, e.g. the answers to questions based on user-specific knowledge. Additionally, the user record can hold other user information, such as name, address, phone number, email address, loyalty information, identifiers (e.g., a user's SID, PINs, passwords and other user identifiers), and/or other identity verifying information related to an individual seeking authorization within BRRS 100. A user record may also contain additional background information, credit scoring information, and/or time of enrollment data (which may be included for the totality of the user record or for particular fields within the user record). Furthermore, a user record can include financial data, such as information pertaining to credit cards, debit cards, checking account and routing information, and the like. Such financial data can be utilized for processing advance purchase payment or for processing financial transactions associated with transfer of redemption rights, such as their resale by an initial user to a second user.

Additionally, a user record contains information pertaining to the user's redemption right transactions. Redemption rights information can include the brand or type of a purchased item, identifiers of participating operators, the amount or value of items to be redeemed, approval guidelines such as limiting locations, dates or time periods, other restrictions on redemption, and the like. Moreover, the redemption rights information could be transferred or copied from an initial user's record to a second user's (or yet additional users') record at the initial user's request, if the transfer meets approval guidelines. This information is accessed by redeeming operators at the point of redemption in order to indicate that a user is authorized to access the redemption right in question. For example, a user whose redemption rights include access to Disney World on May 4 could present his biometric data as well as any other necessary identifying information, for example an identifier such as an SID, at authorization station 106 located at a point of entry to the park. BRRS 100 could utilize the submitted data to locate the appropriate user record at database 104 in order to determine if the redemption right for access to the park on that day is indicated in the user record.

In addition, a user record can include information regarding other individuals authorized to redeem advance purchased items via BRRS 100. Such information could include identifiers for other users enrolled in BRRS 100 that would point to their user records, or names, addresses or other identifying information as necessary to satisfy guidelines for authorization approval. For example, an initial user, i.e., the user who first purchases the redemption right, can allow additional family members to redeem an advance purchased redemption right to an amusement park. These additional authorized users can be enrolled in BRRS 100 and have their own user records linked to the initial user's or can be solely associated with the user's record. Additional authorized individual data can include a variety of information, such as biometric data, preexisting token data, identifiers, and/or other identity verifying information related to the additional authorized individual. If the additional authorized individual is himself a user in BRRS 100, additional authorized individual data in the initial user's record can direct the system to the additional authorized individual's own user record. Conversely, information relating to the redemption right could be stored in the user records of additional authorized users enrolled in BRRS 100, enabling the additional user to access the redemption right when presenting biometric data linked to his user record. A user can establish parameters for additional authorized users included in or linked to his record. For example, a user can indicate that a particular additional user, such as a child of a user making an advance purchase, can redeem only specified portions of the advance purchase. For example, the child might be authorized to redeem event access, but not be authorized to redeem pre-purchased food and beverage items without the authorization of the initial user, and these restrictions could be noted with the redemption rights information contained in the child's user record. Other flows of authorization for redemption right access can be envisioned without limiting the scope of the invention. For example, an additional authorized user's identifier could be contained in the initial user's record. When this additional authorized user presented his biometric data, the identifier contained in his user record could be used to search for the initial user record, containing a matching identifier, thus identifying this additional user as authorized for accessing some or all of the redemption rights belonging to the initial user.

The user record can be maintained for continuous use or for a limited amount of uses. For example, BRRS 100 can function on a single advance purchase transaction basis in which the user record is only maintained until the advance purchase is fully redeemed. After the advance purchase has been fully redeemed, the user record can be deactivated or eliminated.

In one scenario, BRRS 100 can be part of a broader biometric authorization system that processes authorizations for other applications in addition to advance purchases and redemptions. For example, the system can conduct financial transactions, age-verification, vehicle rental procedures, locker rentals or the like. In accordance with the present invention, enrollment in BRRS 100 would include configuring a user record in this broader system to handle the transfer of redemption rights between users. Additionally, an enrollment promotion can be incorporated with user enrollment. For example, a user that registers via the Internet could purchase a discounted vacation package through a travel services merchant affiliated with BRRS 100.

An operator record can be designed to include information useful for authenticating an operator (e.g. for login or tracking purposes), such as a name or ID number, device ID numbers associated with the operator, an address, and a phone number. An operator may be an individual or entity, such as a merchant or clerk employed by a merchant, that has administrative capabilities in a BRRS, but is not directly employed by the BRRS service provider. These capabilities may range from being permitted to oversee a biometric authorization to having access to user records. For example, in the present invention, an operator may be a travel agent or a merchant. In an alternate embodiment of the present invention, the operator records also include employer information if the operator is an employee of an employer who is also an operator. In another embodiment of the present invention, operator records include an operator identifier, such as an SID, and/or operator biometric data. The operator record could also be linked to transaction information, for example, transaction logs contained on a merchant's database. For example, a travel agent's operator record could be linked to redemption rights sold on behalf of various operators utilizing the system, which could be useful for maintaining records, offering employee incentives based upon sales and the like. In one scenario, an operator may need to undergo biometric authorization before administering a user's biometric authorization.

Database 104, operator database 107 and third-party database 108 are connected to network 102, which may be, but is not limited to, the Internet. Networks used in additional embodiments include local area networks (LANs), wide area networks (WANs), and telephone networks. Network 102 comprises connections to at least one of a plurality of authorization stations (AS) 106a-106f where a user can be biometrically authorized. AS's 106a-106f can include, but are not limited to, at least one attached biometric input device (BID) and the necessary means for sending and receiving information to and from a user and to and from a database. These stations include but are not limited to a vending machine, a kiosk, a personal computer, a user service desk, a point of sale terminal, a telephone, and a mobile device connected via a wireless network. The BID is illustrated in FIG. 1 as a peripheral device for purposes of emphasis only. AS's 106a-106f could also include integrated BIDs. In one embodiment, one or more of AS 106a-106f could simply be a BID connected to BRRS 100. Operator database 107 could include one or more databases maintained by operators, e.g. merchants, affiliated with BRRS 100. Operator database 107 could maintain transaction records regarding redemption right sales and transfers, approval guidelines for sales and transfers and the like.

Additional embodiments of the system also comprise connections to one or more third party information sources, such as third-party database 10t, in which user information could be verified and/or from which user information, such as credit information, could be retrieved. The system can be connected to one or more financial sources in order to facilitate the initial financial transaction. For example, a user record stored at database 104 could indicate an account held at a financial institution 103 from which a user would biometrically authorize payment for advance purchased items. In an alternate embodiment, a user could pay for a redemption right utilizing payment means not dependent on BRRS 100, and BRRS 100 could be used to store information about and enable access to and transfers of the purchased redemption right.

Information transferred in the system can be encrypted. For example, information may be encrypted at one point and sent across a non-secure connection between points or not encrypted at a point of communication and sent to the other point of communication across a secure connection. Encryption and decryption of these messages can be monitored by services provided by a security company such as VeriSign. In one scenario, as an added level of security, information internal to a terminal and which is never transmitted can also be encrypted. This prevents retrieval of sensitive information (e.g., biometric data) from a stolen terminal. In an additional embodiment, the system incorporates one or more anti-tampering methods by which to recognize authentic and non-authentic system requests.

In one embodiment of the present invention, user information is shared among a subset of affiliated operators, such as merchants who collectively offer items to be sold and redeemed as part of a package deal, and stored in select multiple-operator databases 107 or select multiple-operator partitions within database 104. In this embodiment, a group of operators share data with each other regarding users who have pre-purchased items from the affiliated operators or from an agent acting on their behalf. Operators could be linked by, for example, a shared operator identifier contained in the redemption rights information. This system allows affiliated operators to share information without sharing that information with all other non-designated operators who might be registered in the system. For example, if BRRS 100 is also set up to perform biometrically authorized financial transactions, the pre-purchased redemption account information might only be accessible to an affiliated subset of operators, as an example utilizing AS's 106a-106c, who have offered their items as part of the redemption package, and not by all operators who might utilize BRRS 100 for processing financial transactions, i.e., those utilizing AS's 106d-106f information in such a system can be shared between one or more databases freely or sharing can be monitored by rules set in the one these databases or a combination thereof. By way of illustration and not as a limitation, one operator might only want to share user authorization information with one of five selected operators; for example, a cruise ship line could share authorization information with selected merchants located at various ports of call visited by the line. Operator databases 107 could be configured to immediately share and update data about a redemption right over network 102 whenever a purchase, transfer or other change transpires, or such updates could be communicated at set times and intervals according to system parameters. For example, a travel agent database could store information regarding a user purchasing a redemption right to a travel package and communicate information about the purchase to databases of affiliated merchant operators as well as sending information to update the stored user record in database 104. In another embodiment, all affiliated merchant operators could be assigned a partition in database 104 to which the travel agent database could send information about redemption right purchases and the purchasing users.

In another embodiment, the system is configured as a closed, single operator system, where information entered into the system via a specific operator AS is transmitted to and stored in database 104 specific to that operator, and this information is not shared with another AS or database. In this closed embodiment, database 104 and the operator database could be one and the same, e.g. a proprietary system operated by a single merchant. This is referred to as a “closed” system because users need to enroll in the database in which they would like to perform biometric authorizations. For example, if one operator both provides and dispenses all of the items included in the advance purchase, the operator might desire a closed system. A “closed” BRRS 100 operated by Disney Corporation, for example, could be used both to pre-sell and authorize redemption of accommodations, event and theme park access, food and beverages, parking and the like. Database 104 in closed systems can communicate with other databases, such as third-party database 108. However, all user information that is enrolled into a particular database is stored in that database. In an alternate embodiment of the closed system, information is stored in a partitioned database 104. Operator-related information is stored in operator-specific partitions and is closed to all other operators. Only an authorized operator and authorized entities, such as an agent, may access that partition of database 104. In yet an additional embodiment, information stored in one database or database partition can be stored in another database or database partition. Such an embodiment is useful for information protection in the event database information is lost.

The configuration of the system as a “shared among affiliated operators” system or a “closed”, single-operator system illustrates various ways of implementing the principles of the present invention. System configuration might be determined by the system in which user information is used. As previously mentioned, a merchant who is an operator in the system and who markets packages of pre-purchased items for travelers coming to his location might have a system configured with his own database. In this system configuration, the merchant's database files only exist on the database and are retrieved or accessed for biometric authorization only by pre-determined stations connected to the database; therefore, the system would be a “closed” system.

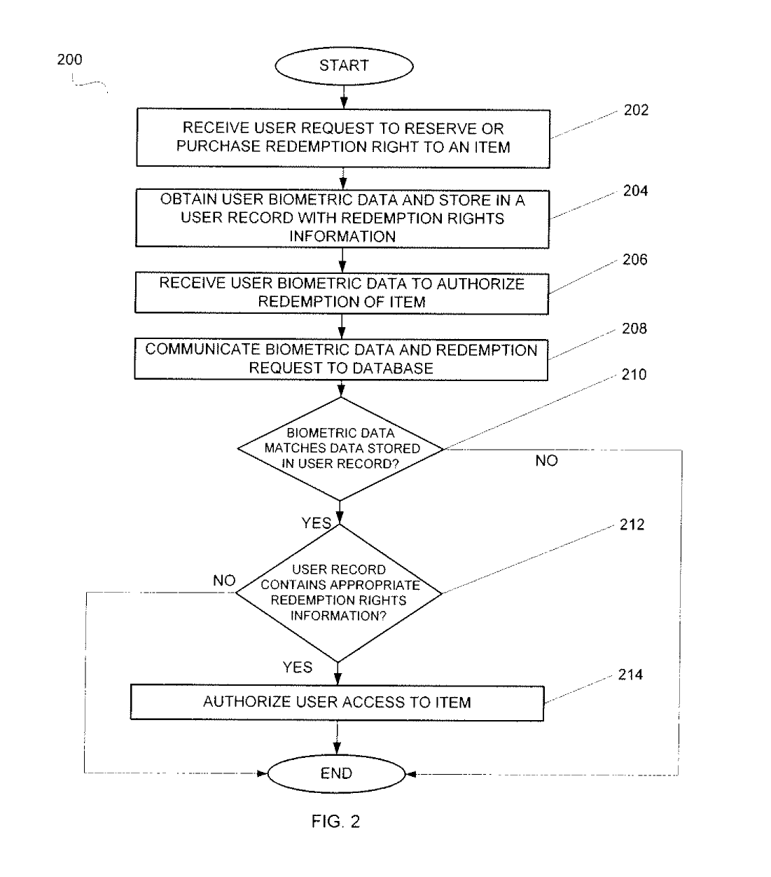

FIG. 2 illustrates a process for making an advance purchase and redeeming a portion or all of the advance purchase at an authorization station via BRRS 100.

At step 202, a user makes a request to reserve or purchase a redemption right to a product or service to be redeemed at a later date. BRRS 100 utilizes financial account information stored in the user record in order to communicate with financial institution 103 and process the purchase transaction. In one embodiment, the products or services are offered as a package, which could he related to a particular destination. For example, a clerk employed by a travel agency or travel service provider could sell a redemption right to a vacation package to a user including access to events, products, or services provided by affiliated operators at the user's desired travel destination. Additionally, the items could be discounted only for packaged pre-sale. In another embodiment, the user reserves the redemption right and agrees to complete payment at a later time. The user could make a deposit on the package at the time of purchase, agree to a schedule of payments, or complete payment when the redemption right is accessed. In an alternate embodiment, BRRS 100 could handle rights redemption and transfer without processing payments.

At step 204, the user's biometric data is obtained and, for a non-enrolled user, stored in a new user record at database 104 along with other user information, such as redemption rights information, as required. For example, identity verification information, purchase information, redemption rights information, including operator identifiers, such as a number or code corresponding to a particular operator, financial account information, age verification information and the like can also be entered into the user record. Redemption rights and user information could also be stored in one or more operator databases 107, for example, in a transaction log. For example, redemption rights information containing operator identifiers could be utilized by a communications server linked to database 104 to communicate redemption rights and purchaser information to operator database 107 of an affiliated operator. If the user is already enrolled in BRRS 100, the obtained biometric data could be confirmed by comparison with biometric data previously stored in the user record, for example, to authorize payment for the package of items. If the user is not enrolled in BRRS 100, he could fully enroll at the time of purchase, or a temporary user record could be created for the user that would be valid until the purchase was fully redeemed or until the expiration of a fixed period of time. Once the user is enrolled and has purchased or reserved the redemption right, the user or other authorized individuals can then proceed to redeem the items.

At step 206, the user presents his biometric data at AS 106 to redeem at least a portion of the product or service. For example, the user may attend a special event at a drinking establishment at his vacation destination, or the user may have redemption rights for a set number of products, such as meals or beverages, and could submit biometric data to redeem each meal or beverage. At step 208, a redemption request that includes at least user biometric data and information identifying the operator originating the request, such as an operator identifier or a terminal identification number, is communicated to database 104. At step 210, the user's submitted biometric data is compared to registered biometric data in the user record to determine if the user is eligible to access the redemption right. If the received biometric data matches the registered biometric data and a determination is made, at step 212, that the associated user record contains appropriate redemption rights information, the user is deemed eligible. The determination of eligibility could be made in a number of ways. As an example and not a limitation, the operator identifier could correspond to an operator identifier stored with the redemption rights information contained in the user record. In another example, a terminal identification number of AS 106 could be compared to a list of terminal ID's of participating operators in order to determine the entity operating AS 106 at the point of redemption, and the identifier of this operator could be compared to operator identifier information stored in the user record.

If, at step 212, the user record is determined to contain appropriate redemption rights information, then, at step 214 the user is authorized to redeem at least a portion of the product or service, and the user record is updated appropriately. Redemption could involve receiving a product from an operator affiliated with the system, or receiving access to a location or event. For example, access might be provided to a happy hour or party for redemption right holders only, to a hotel, and/or to an attraction or other entertainment venue.

If the system determines, at step 212, that the user's redemption right has been fully redeemed, full redemption could be noted in the user record. In an alternate embodiment, the user record could be deleted upon full redemption. The user could additionally be notified when the redemption right has been fully redeemed, and could be given the option to purchase additional items. In an embodiment where user enrollment is typically temporary, the user could also be given the option to maintain his user record in the system as a convenience should he wish to initiate a redemption right transaction at a future date. The user might alternatively be notified of an impending user record expiration and offered the opportunity to renew the user record, possibly for a fee.

In one embodiment, the user could redeem products or services, such as pre-purchased beverage or food items, by presenting biometric data at an automated AS 106. For example, the user could receive printed conventional event tickets by submitting biometric data at an authorization station configured to function as a ticket-vending kiosk. For the dispensing of alcoholic beverages, the machine could be additionally enabled to control or limit distribution of products based on approval guidelines, such as required confirmation of age verification by an operator monitoring AS 106 by camera, an amount distributed in a designated time period, or a breathalyzer requirement. An AS 106 equipped with an automated vending machine could similarly be monitored by a camera or an attendant to make it more difficult for the user to obtain an age-restricted product illegally for an under-age companion.

In an alternate embodiment, the user's advance purchase could include a prepaid value account that would allow him access via the presentation of biometric data to multiple participating merchants in a particular locale or locales. For example, a user who pre-purchases a travel package through a cruise line could he able to use his biometric to redeem items at one or more merchants located at the ports-of-call his cruise ship visits, as well as on the ship itself. The account could have an auto-refill feature that reloads the redemption value after the limit is met. Alternatively, the system could charge the user's credit card if the redemption value is exceeded. Unlike typical “stored value” accounts, the redemption value would only be redeemable at approved merchants affiliated with the system, and only for specified products or services, rather than a monetary value.

In an additional embodiment, the user can adjust redemption rights information contained in his user record via any available AS 106 in communication with the system, such as a kiosk, service desk, system website or a handheld mobile device. For example, the user could be allowed to add more value to an advance purchase, cancel the advance purchase, request a refund of a portion of the value of the advance purchase, provide information about authorized additional users, alter one or more products or services included in the advance purchase, alter the time and location of redemption, or receive and take advantage of other offers and incentives from system merchants.

In another embodiment, user biometric data submitted at the time of purchase and at the point of redemption might additionally be verified by comparison and matching with registered user biometric data stored at third-party database 108, such as a government driver's license/identification database

As part of a system for advance purchase and redemption of selected items, the present invention provides an embodiment of an application that further leverages the system. The present invention describes the use of BRRS 100 to enable the sharing or transfer of a redemption right between a user who is authorized to redeem an advance purchased product or service, hereafter referred to as an initial user, and one or more other users, including a second user to whom the redemption right is transferred, and/or a redeeming user, who ultimately redeems the product or service and may or may not be the second user.

The initial user could have purchased or reserved the redemption right directly from a merchant who participates in or shares information with the BRRS. When the initial user requests a transfer of a redemption right to a second user, the system could verify for the second user that the initial user is the authorized owner of the redemption right to the product or service and could implement the secure transfer of the redemption right to the second user. The system could also communicate information about the transfer of the redemption right to the redeeming operator or operators. Operators, for example, merchant entities, could maintain transaction records or logs at operator database 107 tracking the sale and transfer of redemption right, which could be updated via communications from database 104 when transfers take place, or on a periodic basis. For example, a user record could contain redemption rights information, including the redeeming operator identifier or identifiers. When this redemption rights information is transferred to a second user, the system could utilize the operator identifier(s) to determined which redeeming operators to notify about the transfer.

BRRS 100 could be administered by the operator or by a third party, such as a BRRS provider that maintains the BRRS and has a contractual relationship with operators utilizing the system, and could set approval guidelines, possibly in cooperation with operators, such as merchants, governing resale of purchased rights that allow legitimate resale while excluding or discouraging professional/bulk resellers or scalpers. Approval guidelines are accessed when a redemption right transfer is requested, and could be included with the redemption rights information stored in the user record at the initial sale of the redemption right, or they could be stored at operator database 107 and could be queried utilizing an operator identifier included in the redemption right when a transfer is requested. For example, the system could allow a limited number of resales by a user over a period of time and could set limits on the resale price of redemption right. Operator approval guidelines could be particularly advantageous because they allow operators utilizing the system to exercise more control over the flow and transfer of ownership of redemption rights to items.

In a scenario where the second user is already enrolled in BRRS 100, the transfer could be implemented by updating the user records of the initial user and the second user to reflect the transfer or sharing of redemption right. If the second user is not enrolled, BRRS 100 could collect necessary enrolling information and create a user record for the second user, including at least his biometric data, and transfer the redemption right from the initial user upon completion of a resale or transfer transaction. If the second user prefers to enroll at a later time, BRRS 100 could alternatively provide the second user with a pass code that could be utilized subsequent to his enrollment in order to effect the transfer of the redemption right to his user record, at the same time invalidating the initial user's means of accessing the transferred rights. When an initial user initiates a redemption right transfer to a second user, he could be required to submit information about the second user, such as an identifier of an enrolled user, or an email address or other contact information of a non-enrolled user. If necessary, the second user could then be provided with enrollment instructions, enrollment locations, or directed to a system website to complete the enrollment and transfer process.

As previously mentioned, multiple resales and transfers of a redemption right could be possible. In this scenario, one or more users could receive and resell or transfer the redemption right, as permitted by approval guidelines, before their redemption by a redeeming user.

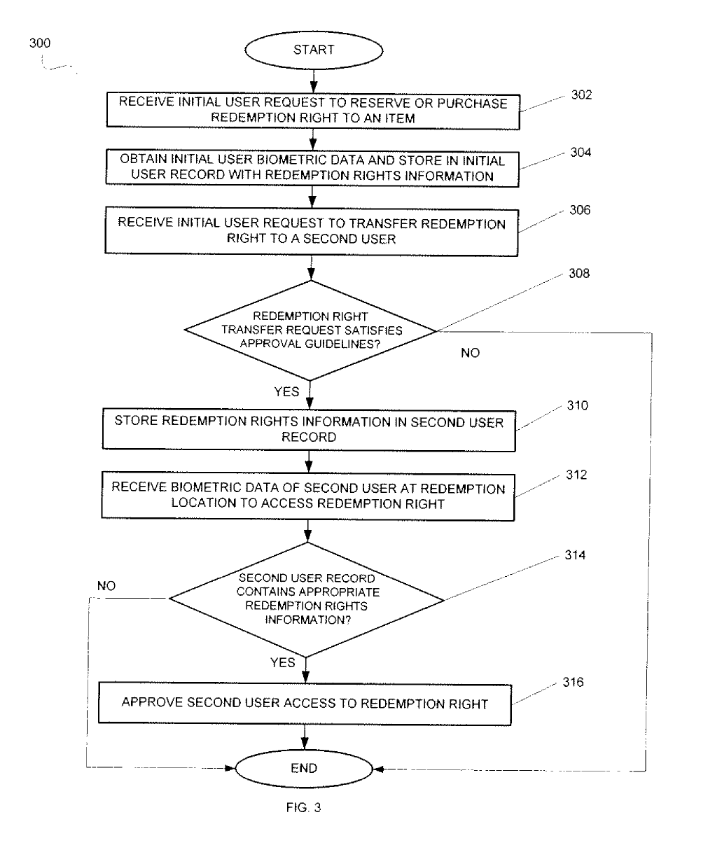

FIG. 3 illustrates a flowchart of a process for advance purchase and transfer of redemption rights via BRRS 100. At step 302, an initial user makes a request to purchase or reserve a redemption right to a product or service. In one embodiment, the products or services are offered as a package, which could be related to a particular destination. For example, a clerk employed by a travel agency or travel service provider could sell a redemption right to a vacation package to a user, including access to events, products, or services provided by affiliated operators at the user's desired travel destination. Additionally, the items could be discounted only for packaged sale.

At step 304, the initial user's biometric data is obtained at AS 106 and stored in a user record at database 104 along with redemption rights information and other user information as required. For example, identity verification information, purchase information, financial account information, age verification information and the like can also be entered into the user record. If the initial user is already enrolled in BRRS 100, the biometric data and/or other information could be confirmed by comparison with biometric data and other information previously stored in the user record and, if BRRS 100 is enabled to conduct financial transactions, could be used to authorize payment for the items. In this scenario, BRRS 100 could utilize financial account information stored in the user record in order to communicate with financial institution 103, which could represent financial institutions where the user is an account holder as well as the financial institutions maintaining the accounts of one or more operators offering a redemption right for sale, and process the purchase transaction. If the initial user is not enrolled in BRRS 100, he could enroll at the time of purchase, or a temporary user record could be registered for the user that would be valid until the purchase was fully redeemed or until the expiration of a fixed period of time. In one scenario, an initial user record could include only the initial user's biometric data and information about the redemption right, without any further user identifying information.

As aforementioned, redemption rights information is stored in the user record at database 104. This information could include which items may be redeemed, dates, times, and location of redemption, merchant identifiers, transfer approval guidelines, identifying information about additional persons authorized to redeem the purchase (e.g., biometric data, user identifiers such as an SID, etc.), other restrictions on redemption, and the like. Redemption rights information and user information could additionally be stored in one or more operator databases 107 or in an operator-specific partition in database 104, for example, in a transaction log. As an illustration and not a limitation, redemption rights information containing operator identifiers could be utilized in combination with a BRRS service provider communications server linked to database 104 to communicate redemption rights and purchaser information to operator database 107 of an affiliated operator corresponding to the operator identifier. Once the initial user is properly enrolled or registered, has paid for or reserved the items and the redemption rights information is stored in the initial user record, the initial user could re-sell or transfer his redemption rights for the items.

At step 306, the initial user communicates a request to the system to transfer all or a portion of his redemption rights to a second user. As previously mentioned, when an initial user requests a redemption night transfer to a second user, for example, by filling in a transfer request form at a system website, he could be required to submit information about the second user, such as an identifier (e.g., an SID) of an enrolled user, or an email address or other contact information of a non-enrolled user. The transfer request could be communicated from the initial user to BRRS 100 via a system website, email, telephone, text message, or the like. The request could include a transaction sale amount that could be subject to approval guidelines, which could be defined both by the system and affiliated operators, contained in the redemption information stored with the initial user record at database 104, or accessed at operator database 107 via an operator identifier contained in the redemption information. Various system- and operator-defined approval guidelines may be envisioned, such as standard transaction rules stored at database 104 that must be satisfied for any redemption right transfer request to be approved. If the initial user record and the second user's record contain financial account information, BRRS 100 could be utilized to authorize monetary transfers between financial accounts of the initial user and the second user via biometric authorization, and, if approved, could process the redemption right resale transaction.

The system makes a determination, at step 308, whether the redemption right transfer request meets one or more approval guidelines. As aforementioned, approval guidelines could be system- or operator-defined, stored as part of the redemption rights information in the user record, stored separately at database 104 or accessible at operator database 107, and could include, for example, velocity limits or other limitations on additional user authorizations in order to prevent gray market reselling of the redemption right. For example, an initial user owning redemption rights for multiple advance purchases could be allowed only a limited number of redemption right transfers during a given time period, or the initial user could be assessed a fee for reassigning ownership to the second user (for example, the amount a ticket was originally discounted) to prevent professional scalpers from abusing the system. If BRRS 100 processes the sale transaction, the system and/or operators could also set approval guidelines on the resale price, such as requiring that resale not be for an amount above market value, and/or set other resale guidelines as desired. Approval guidelines could also be in place to prevent improper transfer of redemption rights. For example, an initial user could be prevented from transferring a redemption right for an event that had already taken place, or to an event that was age-restricted without proper evidence of the second user's eligibility to attend, such as age verification on file. Additionally, BRRS 100 could utilize GPS tracking, triangulation, or terminal identifiers to ascertain the location of the initial and second users in order to enforce restrictions on resale or transfer. For example, a theme park redemption right package that was initially purchased at a discount might only be eligible for resale to a second user at locations remote from the theme park itself.

If the redemption right transfer request meets approval guidelines, the transfer is approved, and redemption rights information is stored, at step 310, in the second user record. At the same time, the initial user's ownership of the transferred redemption right could be revoked. For example, the initial user's record could be updated to note the relinquishment of the transferred redemption right, redemption rights information could be removed from the initial user's record, or the initial user record could be deleted. Furthermore, information about the transfer of a redemption right could be communicated to the redeeming operator or operators. For example, when an initial user transfers a travel package redemption right to a second user, the present invention could utilize operator identifiers contained in the redemption rights information and a communications server connected to database 104 to transmit information about the transfer to the appropriate operators. Such a communication could be made via email or other means, or operator database 107 could receive automatic updates from BRRS 100 when transfers take place. Information communicated to operators could include the specific items specified by the transferred redemption right, the identity of and contact information for the second user purchasing the redemption right, other relevant demographic information about the second user, details of the transfer transaction, such as the resale price, and so on.

In an additional embodiment, if the second user is not enrolled, BRRS 100 could collect necessary enrolling information and create a user record for the second user at the time of the transfer request, including at least his biometric data, and transfer the redemption rights information from the initial user record to the newly enrolled second user's record. If the second user prefers to enroll at a later time in order to complete the rights transfer, BRRS 100 could provide the second user with a pass code that could be utilized after his enrollment in order to complete the transfer of the redemption right to his user record, while invalidating the initial user's means of accessing the transferred redemption right. BRRS 100 could maintain a record of pending redemption right transfers awaiting second user enrollment and submission of the appropriate pass code.

In order to prevent an initial user from utilizing knowledge of a pass code to fraudulently sell a redemption right to more than one user, the pass code could be communicated to or chosen by the second user without the knowledge of the initial user. When the second user enrolls, for example at a system website or at a kiosk, the pass code could be submitted in order to identify the redemption right he has purchased, and to associate the redemption right with the second user's new user record.

At step 312, the second user presents his biometric data at AS 106 at a point of redemption right access and his user record is located for determination of redemption approval. One skilled in the art will appreciate that there are a number of ways that the user record could be located, and that other variations of locating the user record would be possible without departing from the scope of the disclosed invention. The submitted biometric data could be used alone, or in combination with an identifier such as a user identifier or an operator identifier, to locate the second user record at database 104. For example, if biometric data alone were used, the system could locate the second user record by comparing biometric data stored in user records at database 104 with the submitted biometric data until a user record containing matching registered biometric data was found. To narrow the search, the system could utilize a non-unique identifier, such as a PIN. Alternatively, operator information, such as an operator identifier or a terminal identifier associated with a particular operator, could be utilized to search only user records containing the appropriate operator identifier for matching biometric data. In another scenario, a unique identifier could point to one user record containing registered biometric data to be matched with the submitted biometric data.

If the located user record is determined, at step 314, to contain redemption rights information corresponding to a an operator identifier associated with AS 106 at the point of redemption and meeting approval guidelines, e.g. time and date restrictions or the like, BRRS 100 at step 316 communicates an approval message to AS 106. Alternatively, the second user's identifier could be used to locate the user record in step 312, retrieve registered biometric data and stored redemption rights information from his user record and communicate it to AS 106 for biometric matching and redemption right approval. IT redemption of the product or service is approved, redemption rights information in the second user record is updated appropriately. BRRS 100 could also communicate information about the redemption to operator database 107 or to an operator-specific database partition in database 104. For example, redemption rights information could include a unique number associated with the initial advance purchase transaction; the number could be utilized to locate the transaction on an operator transaction history log, and the transaction could be noted partially or fully redeemed as appropriate.

As previously mentioned, the second user is the redeeming user in this scenario, but the system could allow for an additional transfer from the second user to another user, and so on, before the redemption right is ultimately redeemed.

In one scenario, as previously noted, the redemption right transfer could be for an item that has been reserved, but not purchased. For example, an initial user could reserve a hotel room or a flight without tendering payment, with the reservation information being stored in the initial user record. The initial user could then transfer the reservation to a second user as detailed above, subject to the transfer satisfying system and operator approval guidelines.

BRRS 100 could charge the initial user and/or the second user a fee for the transfer of redemption rights for products or services through the system. The transfer fee could be a flat fee or a percentage of the selling or resale price, or a combination thereof, and could be collected from the initial user, the second user, or both. Moreover, the transfer fee could be constant or could vary per transaction. If the initial user record and second user record contain financial account information, the fee could be assessed automatically by BRRS 100 and debited from an appropriate user financial account. The fee could be assessed as a service charge by the BRRS service provider or could be assessed on behalf of the selling or redeeming operator or operators, or any combination of the BRRS service provider and affiliated operators. A portion of collected fees could be credited by BRRS 100 to affiliated operators at the time of redemption right transfer, or as a batch payment of cumulative fees at predetermined intervals, e.g., once a month.

As an additional feature, the system could provide a venue for the advertising and transfer of redemption rights, such as an online web forum, message board, and the like. For example, BRRS 100 could include a means for advertising redemption rights for sale and communicating with interested users, such as a website where a user could indicate an interest in transferring a redemption right that he owns. Alternatively, the system could be usable in conjunction with third party websites, such as ebay or online social networking providers, such as MySpace or Facebook. Similarly, a user of BRRS 100 could indicate an interest in learning about potential redemption right transfer opportunities from other users. The indication of interest could be stored in his user record. The user could specify an interest in particular types of redemption right transfers, for example, those related to a particular event, location, product or service. The system could communicate to the user redemption right transfer opportunities of interest when they became available. For example, if an initial user posted an interest in reselling a redemption right that he had purchased for a travel package to the Bahamas to a system website. BRRS 100 could search the user records of other enrolled users, and locate users who had indicated an interest in purchasing such redemption right. The system could additionally leverage information about users contained in profiles, in their relationships, associations, or other transactions within the system or affiliated external/third-party systems to determine potential for interest in redemption right transfer offers. The system could then send a communication about the redemption right transfer offer to one or more potentially interested users. The communication, for example an email or text message, could contain contact information about the user seeking to transfer the redemption right, as well as other information such as details about the redemption right, the asking price for the redemption right trustworthiness of the user seeking to transfer the redemption right (e.g. with an identity score), and the like.

If a user is suspected of fraudulent activity or a redemption right transfer is deemed illegitimate, a redemption right associated with the user could be limited or revoked. Furthermore, users who make improper use of BRRS 100 could be restricted from utilizing the system for future redemption right transfers.

In an additional embodiment, the system could communicate to the second user a confirmation of the legitimacy of the redemption right and verify the transfer of redemption right, and could offer a guarantee of their validity. The system could offer a transaction guarantee to each user in the event that a user defaults on payment or provides fraudulent information. The second user could also initiate a request for confirmation of a transferred redemption right at any time prior to redemption, for example, by submitting biometric data at a kiosk or a personal computer connected to the Internet. BRRS 100 could locate the user record at database 104 and identify the operator or operators to whose items the user holds redemption right, for example, by using an operator identifier stored in the user record. If the user has redemption rights with more than one operator, BRRS 100 could query the user as to which of the multiple redemption rights he wishes to verify. Database 104 could then communicate the request for confirmation to operator database 107 belonging to the issuing operator and provide the second user with operator verification, for example, by locating and providing the second user with an operator confirmation code contained in a redemption right transaction log at operator database 107 or an automated message from the issuing operator, wherein BRRS 100 prompts the issuing operator to respond directly to the user query.

As an additional feature, the system could maintain identity scores or otherwise evaluate transaction histories and trustworthiness for users. The trustworthiness evaluation could be based upon a record of user biometric authorizations utilizing BRRS 100, a history of user transactions utilizing BRRS 100, identity verifying information presented by the user during or subsequent to enrollment, testaments or supporting information from third parties, information related to the quality and nature of the user's online associations and transactions (e.g., as part of an affiliated third-party online community such as ebay or Facebook), information, such as credit history information, shared from third party database 108, and the like. The system could enable the initial and second user to request and view their respective system evaluations, such as identity scores or a representation of the scores, that would provide information relating to the verifiability and trustworthiness of the users. The initial and second user could consider trustworthiness evaluation information provided when deciding whether to proceed with a redemption right transfer transaction. Additionally, the system could allow users to define relationship levels based on the nature of the relationship, the type of transaction, outcome of transaction, and the like, and the system could take such information into account when evaluating user trustworthiness.

A system and method of sharing or transferring ownership of a biometrically accessed redemption right for advance purchased or reserved items from an initial user to a second user has been illustrated. It will be appreciated by those skilled in the art that the system and method of the present invention can be used to offer and provide biometrically enabled redemption of the items via a biometric redemption rights system, as well as a means of transfer or resale of the redemption rights for such items. It will thus be appreciated by those skilled in the art that other variations of the present invention will be possible without departing from the scope of the invention disclosed.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention. Therefore, the above description should not be considered to be exclusive of these other embodiments. Also, it is to be understood that the phraseology and terminology employed herein are for the purposes of description and should not be regarded as limiting.

What is claimed is:

1. A method for transferring ownership of a redemption right in a biometric redemption rights system from an initial user to a second user, the method comprising
receiving purchase information related to one or more items to be redeemed at a later date;
storing, in a user record associated with registered biometric data of the initial user, information pertaining to a redemption right relating to the one or more items, wherein the redemption right authorizes the initial user to redeem the one or more items upon provision of biometric data matching the registered biometric data;
receiving, from the initial user, a request to transfer ownership of the redemption right to a second user;
determining whether the transfer request meets at least one approval guideline for ownership transfer; and
transferring ownership of the redemption right to the second user, wherein transferring ownership includes storing the redemption right in a user record associated with registered biometric data of the second user, wherein transferring ownership authorizes the second user to redeem the one or more items upon presentation of the biometric data of the second user.

2. The method of claim 1, further comprising enrolling the second user in the biometric redemption rights system by receiving at least biometric data of the second user for identity confirmation to enable the redemption.

3. The method of claim 1, further comprising enrolling the second user in the biometric redemption rights system by receiving at least biometric data of the second user for identity verification to enable the redemption.

4. The method of claim 1, further comprising receiving from the initial user one or more of identity verification information and contact information related to the second user to enable the transfer.

5. The method of claim 1, wherein the approval guidelines comprise one or more of a velocity limit, a limit on a price associated with the transfer, and operator preferences associated with the redemption right.

6. The method of claim 1, wherein one or more of the initial user and the second user are charged a fee for the transfer.

7. The method of claim 1, wherein the system maintains a trustworthiness evaluation for one or more of the initial user and the second user.

8. The method of claim 7, wherein the trustworthiness evaluation is based in part on a system record of biometric authorizations.

9. The method of claim 1, further comprising providing the initial user a means of offering the redemption right for sale to the second user.

10. The method of claim 9, wherein the means comprise one or more of an online message board, an electronic mailing list, an online community network and a webpage.

11. The method of claim 1, wherein the second user indicates a preference for participation in redemption right transfer transactions.

12. The method of claim 11, wherein the preference indication includes one or more of a type of item, a trustworthiness evaluation of an offering user, and a relationship level with an offering user.

13. The method of claim 1, wherein transferring ownership of the redemption right further authorizes the second user to transfer the redemption right to a third user.

14. A method for sharing redemption rights between users enrolled in a biometric redemption rights system, the method comprising:
at an authorization station, receiving purchase information related to one or more items redeemable at a select set of operators;
storing redemption rights information related to the one or more items in a user record associated with registered biometric data of the initial user;
receiving a request from the initial user to enable a second user to utilize the redemption rights information; and
storing the redemption rights information relating to the one or more items in a user record of the second user, wherein the user record includes registered biometric data of the second user, thereby enabling the second user to redeem the one or more items upon provision of biometric data matching the registered biometric data.

15. The method of claim 14, further comprising relinquishing, by the initial user, a redemption right to the one or more items to the second user.

16. The method of claim 14, further comprising processing a purchase transaction between the initial user and the second user relating to a sale, by the initial user, of the redemption right to the second user.

17. The method of claim 16, further comprising guaranteeing the purchase transaction for the initial user and the second user.

18. A method in a biometric system for transferring a reservation request, the method comprising:
receiving a user reservation request including a reservation of a right to purchase a product offered by an operator in communication with the system;
storing reservation information related to the reservation request in association with user biometric data, wherein the association indicates user ownership of the reservation request;
receiving a user transfer request indicating a transfer of ownership of the reservation request to a third party, wherein the user transfer request comprises user biometric data;
approving the transfer request if the transfer request meets at least one approval guideline;
storing reservation information related to the reservation request in association with third party biometric data, wherein the association indicates third party ownership of the reservation request; and
communicating the reservation information to the operator.
